(19) United States
(12) Patent Application Publication
(10) Pub. No.: US 2025/0259000 A1
(43) Pub. Date: Aug. 14, 2025

(54) INTELLIGENT CONSTRAINED DECODING

(71) Applicant: Scaled Cognition, Inc., Amesbury, MA (US)

(72) Inventors: Emmanouil Antonios Platanios, Fremont, CA (US); Adam Pauls, Berkeley, CA (US); Mitchell Stern, Berkeley, CA (US); Mathew Gardner, Irvine, CA (US); Dan Klein, Berkeley, CA (US)

(73) Assignee: Scaled Cognition, Inc., Amesbury, MA (US)

(21) Appl. No.: 18/751,047

(22) Filed: Jun. 21, 2024

Related U.S. Application Data
(60) Provisional application No. 63/551,069, filed on Feb. 8, 2024.

(51) Int. Cl. G06F 40/211; G06F 40/284; G06N 3/045

(52) U.S. Cl. CPC G06F 40/211; G06F 40/284; G06N 3/045

(57) ABSTRACT

A system provides a language model that utilizes an optimized parser and operates at the byte- level in a context free grammar (CFG) and a tokenizer vocabulary. The CFG is constrained and automatically transformed to a byte-level grammar. A prediction mechanism is used to predict the allowed sequences of bytes that can appear after a given prefix. In some instances, only the next token is constrained so that candidates for the next token can be intersected with tokens in the tokenizer vocabulary. To achieve this, lattice parsing is performed using a finite state automaton (FSA) that is generated and then minimized.

### CROSS REFERENCE TO RELATED APPLICATIONS

The present application claims the priority benefit of U.S. provisional patent application 63/551,069, filed on Feb. 8, 2024, titled “Intelligent Constrained Decoding,” the disclosure of which is incorporated herein by reference.

### BACKGROUND

Language models generate text for many applications. The text can be generated token by token, where each language model (LM) has tokens that are specific to that particular LM. For LMs to be able to interact with real humans, they must be fast, efficient, and accurate. To achieve these goals, LMs need to be able to generate programs and other structured data accurately so that the programs and APIs execute correctly. Existing LMs fail at accurately and quickly being able to generate programs and other structured data. What is needed is an improved LM that operates both accurately and quickly.

### SUMMARY

The present technology, roughly described, provides a language model that utilizes an optimized parser and operates at the byte-level with a context free grammar (CFG). The CFG specifies a set of legal strings (for example, a program). The CFG is automatically transformed into a byte-level CFG using a tokenizer that is provided by the underlying language model. A prediction mechanism is used to predict the allowed sequences of bytes that can appear after a given prefix. In some instances, only the next token is constrained so that candidates for the next token can be intersected with tokens in the language model's vocabulary. To achieve this, each next token is concatenated to any existing tokens and parsing is performed to check if the byte sequence representing that token is accepted by the CFG. Additional optimizations can also be used to make the process faster and more efficient; in particular, a trie or minimized finite state automaton (FSA) may be used to compactly represent all next tokens.

In some instances, the present technology performs a method for performing constrained decoding by a language model. The method begins with accessing a context free grammar (CFG) and then converting the CFG to a byte-level CFG. The system performing the method then constructs a byte-level representation of a tokenizer vocabulary of the language model. The method continues with parsing a byte-level representation of a tokenizer vocabulary of the language model.

In some instances, the present technology includes a non-transitory computer readable storage medium having embodied thereon a program, the program being executable by a processor to perform constrained decoding by a language model. The method begins with accessing a context free grammar (CFG) and then converting the CFG to a byte-level CFG. The system performing the method then constructs a byte-level representation of a tokenizer vocabulary of the language model. The method continues with parsing a byte-level representation of a tokenizer vocabulary of the language model.

In some instances, the present technology includes a system having one or more servers, each including memory and a processor. One or more modules are stored in the memory and executed by one or more of the processors to access a context free grammar (CFG), convert the CFG to a byte-level grammar, construct a byte-level representation of a tokenizer vocabulary of the language model, and parse a byte-level representation of a tokenizer vocabulary of the language model

In some instances, the present technology performs a method for decoding tokens provided by a language model. The method starts with receiving a sequence of token from a language model. The method continues with performing a constrained search for a subsequent token. The subsequent token and the sequence of tokens are then integrated into two or more new sequences of tokens. One of the two or more new sequences of tokens is then selected based on a probability score.

In some instances, the present technology includes a non-transitory computer readable storage medium having embodied thereon a program, the program being executable by a processor to decoding tokens provided by a language model. The method starts with receiving a sequence of tokens from a language model. The method continues with performing a constrained search for a subsequent token. The subsequent token and the sequence of tokens are then integrated into two or more new sequences of tokens. One of the two or more new sequences of tokens is then selected based on a probability score.

In some instances, the present technology includes a system having one or more servers, each including memory and a processor. One or more modules are stored in the memory and executed by one or more of the processors to access a context free grammar (CFG), convert the CFG to a byte-level grammar, construct a byte-level representation of a tokenizer vocabulary of the language model, and parse a byte-level representation of a tokenizer vocabulary of the language model

### BRIEF DESCRIPTION OF FIGURES

FIG. 1 is a block diagram of a system in which constrained decoding can be performed.

FIG. 2 is a block diagram of a language model application.

FIG. 3 is a block diagram of a constrained decoding engine.

FIG. 4 is a block diagram of dataflow for a machine learning model.

FIG. 5 is a method for performing constrained decoding.

FIG. 6 is a method for defining decoding constraints.

FIG. 7 is a method for transforming a constrained context free grammar to a byte-level grammar.

FIG. 8 is a method for performing parsing.

FIG. 9 is a method for performing decoding.

FIGS. 10A-C illustrate example finite state automata.

FIG. 11 is a block diagram of a computing environment.

### DETAILED DESCRIPTION

The present technology, roughly described, provides a language model that utilizes an optimized parser and operates at the byte-level with a context free grammar (CFG). The CFG is automatically transformed into a byte-level CFG using a tokenizer that is provided by the underlying language model. A prediction mechanism is used to predict the allowed sequences of bytes that can appear after a given prefix. In some instances, only the next token is constrained so that candidates for the next token can be intersected with tokens in the language model's vocabulary. To achieve this, each next token is concatenated to any existing tokens and parsing is performed to check if the byte sequence representing that token is accepted by the CFG. In some instances, the set of byte sequences representing all tokens is compactly represented as a trie or minimized FSA, and the parser can efficiently parse the more compact representation.

The present system also uses a decoder to generate a probability distribution over tokens generated by the language model. The probability distribution is used to sample the next token using searching algorithms. The search algorithms are used to find sequences of tokens that have a higher overall score than sequences obtained by other methods, such as for example by greedily choosing a single highest scoring token at each iteration. The searching methods are integrated with constrained decoding and consider possible continuations of a string when deciding which part of a search space to explore.

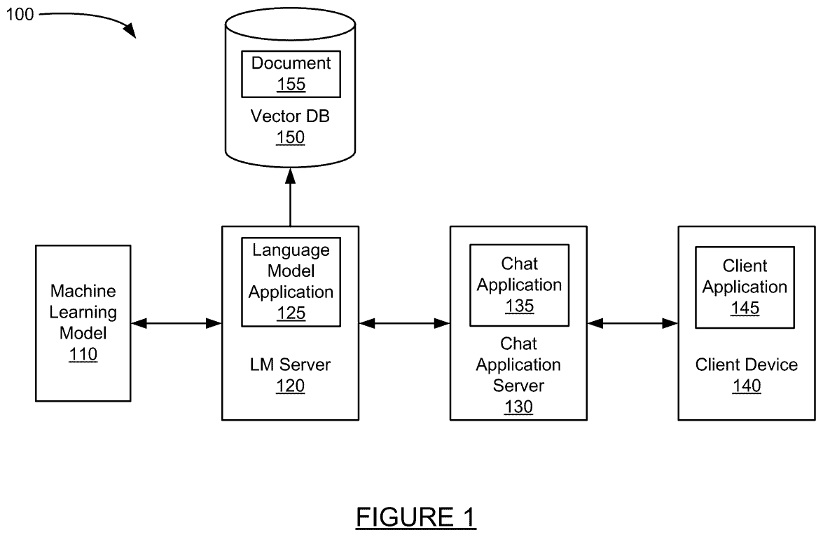

FIG. 1 is a block diagram of a system in which constrained decoding can be performed. The system of FIG. 1 includes machine learning model 110, Language model (LM) server 120, chat application server 130, simulation server 140, and vector database 150.

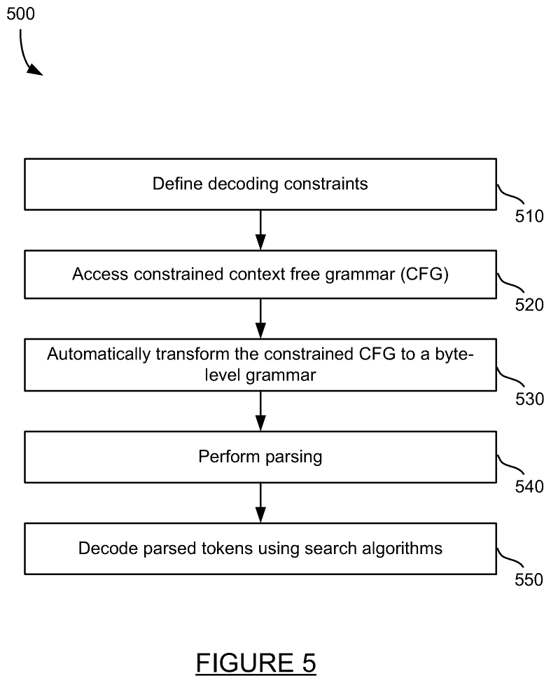

Machine learning model 110 may include one or more models or prediction engines that may receive an input, process the input, and predict an output based on the input. In some instances, machine learning model 110 may be implemented on LM server 120, on the same physical or logical machine as language model application 125. In some instances, machine learning model 110 may be implemented by a large language model, on one or more servers external to LM server 120. Implementing the machine learning model 110 as one or more large language models is discussed in more detail with respect to FIG. 5.

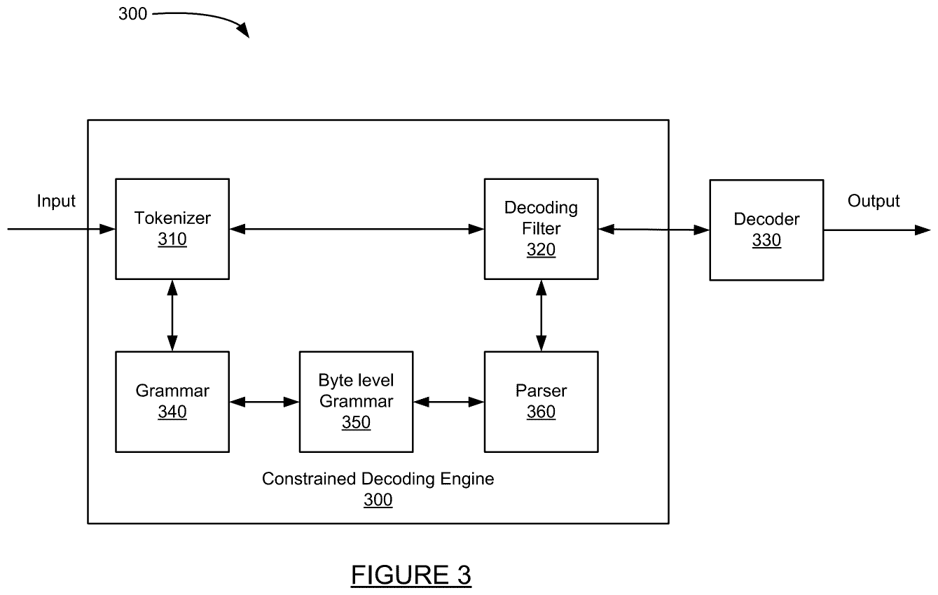

LM server 120 may include an LM application 125, and may communicate with machine learning model 110, chat application server 130, and vector database 150. LM application 125 may be implemented on one or more servers 120, may be distributed over multiple servers and platforms, and may be implemented as one or more physical or logical servers. LM application 125 may include several modules that implement the functionality described herein. More details for LM application 125 is discussed with respect to FIG. 3.

Chat application server 130 may communicate with LM server 120, client device 140, and may implement a conversation and/or interaction over a network, such as for example a “chat,” between an automated agent application provided by LM server 120 and a customer entity.

Simulation server 140 may be implemented as one or more physical or virtual machines logically separate from servers 120 and 130. Simulation server 140 may include simulated user application 145. Simulated user application 145 may initialize and manage the operation of a simulated user in a conversation with an automated agent through chat application 135. The simulated user application may submit requests, process responses, and otherwise communicate through chat application 135. The user application may conduct itself based on scenarios generated from one or more controls.

Vector database 150 may be implemented as a data store that stores vector data. In some instances, vector database 135 may be implemented as more than one data store, internal to system 103 and exterior to system 103. In some instances, a vector database can serve as an LLMs' long-term memory and expand an LLMs' knowledge base. Vector database 135 can store private data or domain-specific information outside the LLM as embeddings. When a user asks a question to an administrative assistant, the system can have the vector database search for the top results most relevant to the received question. Then, the results are combined with the original query to create a prompt that provides a comprehensive context for the LLM to generate more accurate answers. Vector database 150 may include data such as prompt templates, instructions, training data, and other data used by LM application 125 and machine learning model 110.

In some instances, the present system may include one or more additional data stores, in place of or in addition to vector database 150, at which the system stores searchable data such as instructions, private data, domain-specific data, and other data.

Each of model 110, servers 120-140, and vector database 150 may communicate over one or more networks. The networks may include one or more the Internet, an intranet, a local area network, a wide area network, a wireless network, Wi-Fi network, cellular network, or any other network over which data may be communicated.

In some instances, one or more of machines associated with 110, 120, 130 and 140 may be implemented in one or more cloud-based service providers, such as for example AWS by Amazon Inc., AZURE by Microsoft, GCP by Google, Inc., Kubernetes, or some other cloud based service provider.

The system of FIG. 1 illustrates a language model application within a chat system formed with ML model 110, LM server 120, chat application server 130, and client device 140. Illustration of the language model in a chat or automated agent system is for purposes of discussion only, and the language model of the present technology is not intended to be limited to chat systems alone.

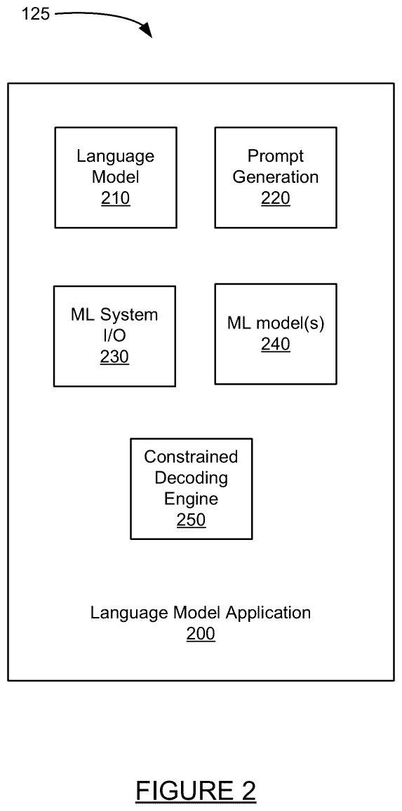

FIG. 2 is a block diagram of an automated agent application. Block diagram 200 provides more detail for LM application 125 of the system of FIG. 1. Automated agent application 200 includes language model 210, prompt generation 220, machine learning system input-output 230, and machine learning models 240.

Language model 210 may implement a language model for performing constrained decoding. The language model may include a tokenizer, parser, and a decoding filter, and may interact with one or more grammars, vocabularies, and other content. The language model constructs a finite state automaton (FSA), minimizes the FSA, and parses the minimized FSA. More details for language model 210 is discussed with respect to FIG. 3.

Prompt generation 220 may operate to generate a prompt to be fed into a large language model. A prompt may include one or more requests, a grammar, one or more previous tokens, a user inquiry, conversation data, instructions retrieved based on the user inquiry, audit data, and optionally other data. The request may indicate what the large language model is requested to do, for example determine a probability that each of several tokens is the best token, determine a next state from the current state, determine a response for a user inquiry, select a function or program to be executed, perform an audit of a predicted response, or some other goal.

Machine learning system I/O 230 may communicate with one or more machine learning models 110 and 240. ML system I/O 230 may provide prompts or input to and receive or retrieve outputs from machine learning models 110 and 240.

Machine learning (ML) model(s) 240 may include one or more machine learning models that generate predictions, receive prompts, instructions, and requests to provide a response to particular inquiry, as well as perform other tasks. The machine learning models 240 can include one or more LLMs, as well as a combination of LLMs and ML models.

Constrained decoding engine 250 operates at a byte-level rather than a token level. The constrained decoding engine automatically transforms the constraining context free grammar to a byte-level context free grammar and adds support for the parser to predict all allowed sequences of bytes that can appear after a given prefix. The present system constrains the next token that the language model will generate so that the system can intersect the potentially infinitely large set with the tokens in the vocabulary of the language model tokenizer.

Determining the intersection would be prohibitively expensive if done naively. The present system achieves this intersection by constructing a finite state automaton (FSA) that accepts the LM tokenizer's vocabulary such that each transition is labeled using a byte value, minimizing the FSA, and scanning the FSA using an efficient lattice parser to obtain all paths through the lattice that correspond to tokens that are prefixes of strings that belong to the language defined by the grammar. More detail for constrained decoding engine 250 is discussed with respect to FIG. 3. Modules illustrated in language model application 200 are exemplary, and could be implemented in additional or fewer modules. Language model application 200 is intended to at least implement functionality described herein. The design of specific modules, objects, programs, and platforms to implement the functionality is not specific and limited by the modules illustrated in FIG. 2.

FIG. 3 is a block diagram of a constrained decoding engine. Constrained decoding engine 300 of FIG. 3 provides more detail for a constrained decoding engine 250 of FIG. 2. Language model 300 includes tokenizer 310, decoding filter 320, decoder 330, grammar 340, byte-level grammar 350, and parser 360.

Tokenizer 310 controls how the language model interacts with the system of FIG. 1 and other components of application 200. The tokenizer, in some instances, decides how to break down strings into tokens that the language model will produce, and provides those tokens to the decoding filter 320 and grammar 340.

Decoding filter 320 connects the tokenizer 310, parser 330, and grammar 340. Decoding filter 320 can construct a finite state automaton based on the tokenizer vocabulary.

Grammar 340 defines the constraints placed on the present language model, and in particular defines what is a valid string that can be produced. Byte-level grammar 350 receives a context-free grammar from grammar 340 and converts the CFG to a byte-level grammar. The CFG provides support to parser 360 to predict allowed sequences of bytes that can appear after a given prefix.

Parser 360 can predict what string or token should come next based on what has been predicted so far. In some instances, the parser performs parsing in alignment with the token using a byte labeled system. In some instances, the parser may be implemented with any general purpose parser that can work with any context free grammar. The parser utilizes a grammar to perform parsing, and may parse in a lattice, by parsing many sequences concurrently.

Decoder 330, which may optionally exist outside of the constrained decoding engine, may operate to generate a probability distribution over tokens generated by the language model. The probability distribution is used to sample the next token using searching algorithms. The searching algorithms are used to find sequences of tokens that have a higher overall score than sequences obtained by other methods, such as for example by greedily choosing a single highest scoring token at each iteration. The searching methods are integrated with constrained decoding and consider possible continuations of a string when deciding which part of a search space to explore.

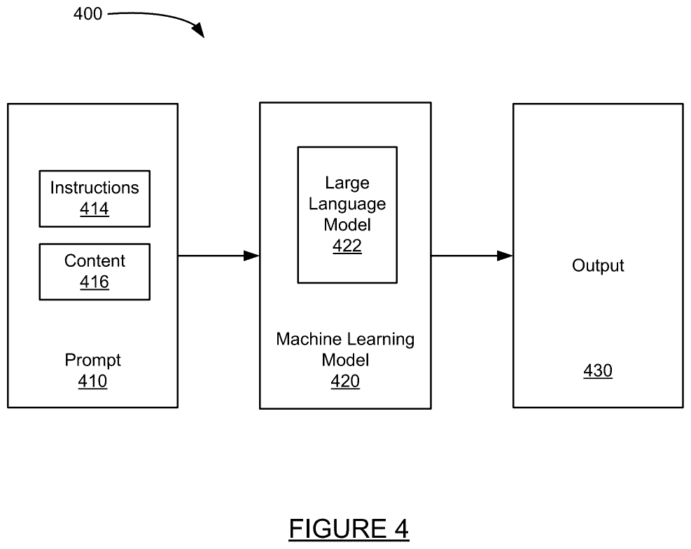

FIG. 4 is a block diagram of data flow for a machine learning model. The block diagram of FIG. 4 includes prompt 410, machine learning model 420, and output 430.

Prompt 410 of FIG. 4 can be provided as input to a machine learning model 420. A prompt can include information or data such as instructions 414 and content 416.

Instructions 414 can indicate what the machine learning model (e.g., a large language model) is supposed to do with the content provided in the prompt. For example, the machine learning model instructions may request, via instructions 414, an LLM to predict a probability that a particular token is the next token in a sequence of tokens, determine if a predicted response was generated with each instruction followed correctly, determine what function to execute, determine whether or not to transition to a new state within a state machine, and so forth. The instructions can be retrieved or accessed from document 155 of vector database 150, locally at a server that communicates or hosts the machine learning model, or from some other location.

Content 416 may include data and/or information that can help a ML model or LLM generate an output. For an ML model, the content can include a stream of data that is put in a processable format (for example, normalized) for the ML model to read. For an LLM, the content can include a sequences of tokens, a conversation between an agent and a user, a grammar, a user inquiry, retrieved instructions, policy data, checklist and/or checklist item data, programs and functions executed by a state machine, results of an audit or evaluation, and other content. In some instances, where only a portion of the content or a prompt will fit into an LLM input, the content and/or other portions of the prompt can be provided to an LLM can be submitted in multiple prompts.

Machine learning model 420 of FIG. 4 provides more detail for machine learning model 110 of FIG. 1. The ML model 420 may receive one or more inputs and provide an output.

ML model 420 may be implemented by a large language model 422. A large language model is a machine learning model that uses deep learning algorithms to process and understand language. LLMs can have an encoder, a decoder, or both, and can encode positioning data to their input. In some instances, LLMs can be based on transformers, which have a neural network architecture, and have multiple layers of neural networks. An LLM can have an attention mechanism that allows them to focus selectively on parts of text. LLMs are trained with large amounts of data and can be used for different purposes.

The transformer model learns context and meaning by tracking relationships in sequential data. LLMs receive text as an input through a prompt and provide a response to one or more instructions. For example, an LLM can receive a prompt as an instruction to analyze data.

In some instances, the present technology may use an LLM such as a Gemini by Google, Falcon 180B by the Technology Innovation Institute, Galactica by Meta, GPT-4 by OpenAI, or other LLM. In some instances, machine learning model 115 may be implemented by one or more other models or neural networks.

Output 430 is provided by machine learning model 420 in response to processing prompt 410 (e.g., an input). For example, when the prompt includes a request that the machine learning model provide a probability that a particular token is the next token in a sequence, the output will include a probability. The output can be provided to other parts of the present system.

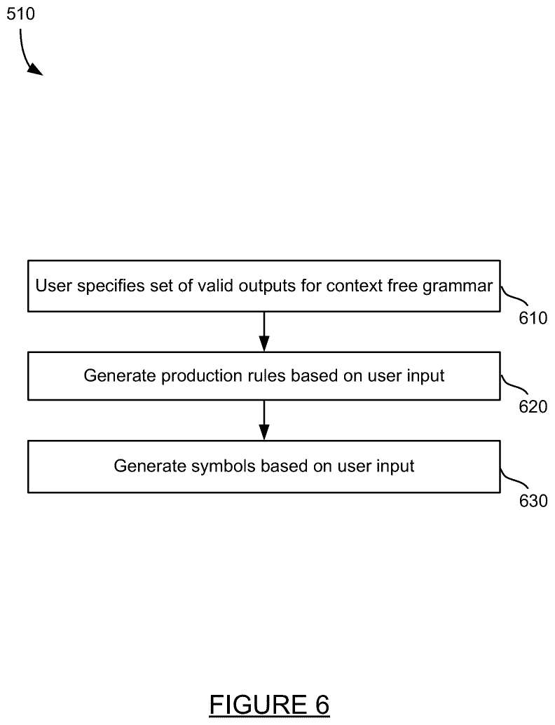

FIG. 5 is a method for performing constrained decoding. Decoding constraints are defined at step 510. In some instances, the present system allows a user to specify a set of valid outputs using a context free grammar. Defining decoding constraints may involve generating production rules and symbols based on user input. Defining decoding constraints is discussed in more detail with respect to the method of FIG. 6.

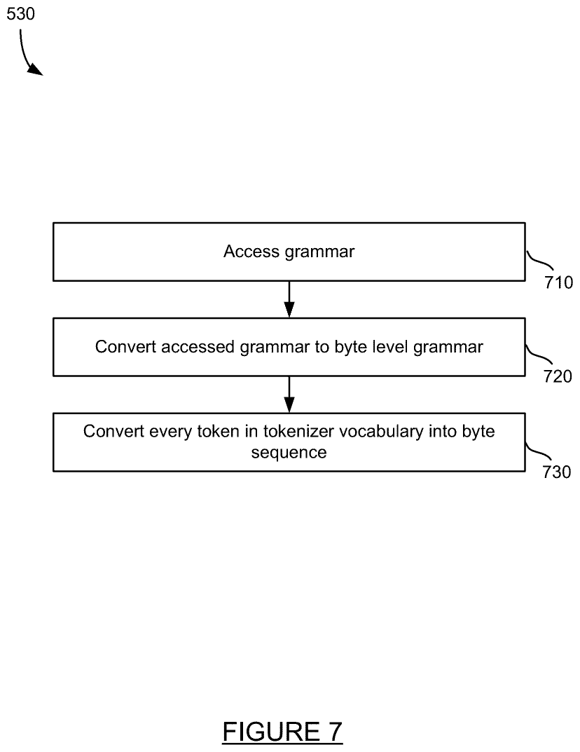

A context free grammar is automatically constructed at step 520. The context free grammar (CFG) is constructed for constrained decoding based on specification data. Automatically constructing the CFG may include accessing an API specification and automatically constructing the grammar for the APIs based on the specification. The API data can include functions, function arguments, and argument types. Creating a CFG with function, argument, and argument type data allows for more specific and accurate tokens to be generated. More details for automatically constructing the CFG are discussed with respect to the method of FIG. 7.

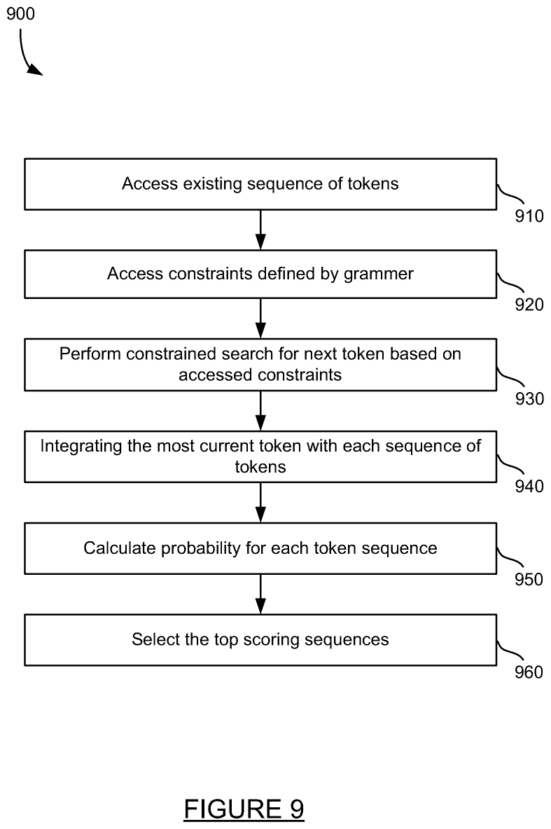

The CFG is automatically transformed to a byte-level grammar at step 530. Automatically transforming the CFG to a byte-level grammar may include breaking every token in the tokenizer vocabulary into a byte sequence. More details for automatically transforming the CFG to a byte-level grammar is discussed with respect to the method of FIG. 9.

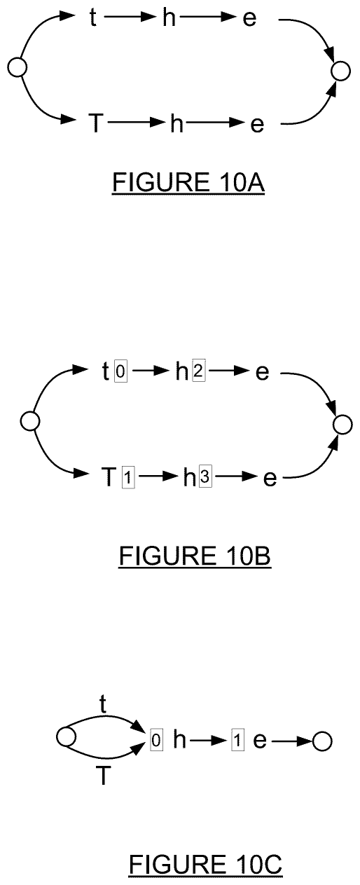

Parsing is then performed at step 540. Parsing may be performed in a lattice manner, where several sequences are parsed concurrently. Parsing may be performed left-to-right using variations of the Earley algorithm. In operation, lattice parsing may include starting at a root of an FSA to determine what bytes come next, determining an intersection with vocabulary the tokenizer, and repeating this process for the remainder of the FSA. More details for performing parsing are discussed with respect to the method of FIG. 10.

Parsed tokens are decoded using search algorithms at step 550. The search algorithms can be used to perform a constrained search for the next token based on constraints defined by a grammar. In some instances, a number of tokens, for example the top two, five, ten, or some other number of tokens, having the highest probability are all applied to one or more sequences, and the probability for each token sequence is determined. The top probability sequences may then be considered along with the next set of tokens. More details for decoding parsed tokens is discussed with respect to the method of FIG. 9.

FIG. 6 is a method for defining decoding constraints. Method of FIG. 6 provides more detail for step 510 of the method of FIG. 5. A user specifies a set of valid outputs for a context free grammar at step 610. The set of valid outputs may relate to a set of symbols and production rules for the grammar. In some instances, the system may generate symbols and production rules based on the input received from the user.

Production rules are generated based on user input at step 620. Symbols are generated based on the user input at step 630. Each production rule may specify that a symbol can produce a sequence of other symbols that may be either terminal or non-terminal, where the terminal symbols never appear on the left-hand side of a production rule.

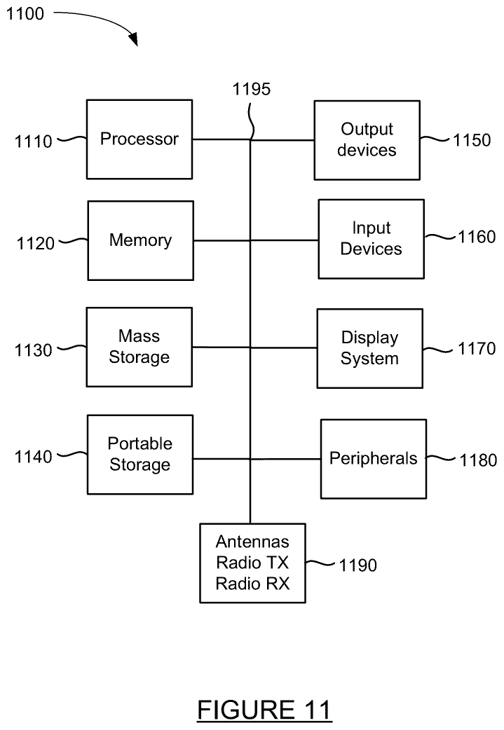

FIG. 7 is a method for transforming a constrained context free grammar to a byte-level grammar. The method of FIG. 7 provides more detail for step 530 of the method of FIG. 5. A grammar is accessed at step 710. The accessed grammar is then converted to a byte-level grammar at step 720. To convert a grammar to a byte-level grammar, a byte value is assigned to each transition within the grammar. Bytes assigned to each transition are illustrated and discussed with respect to FIG. 11.

After converting the accessed grammar, every token in the tokenizer vocabulary is also converted into a byte sequence at step 730. By making these conversions into byte-level content, the present system provides support for the parser to predict all allowed sequences in bytes that can appear after a prefix.

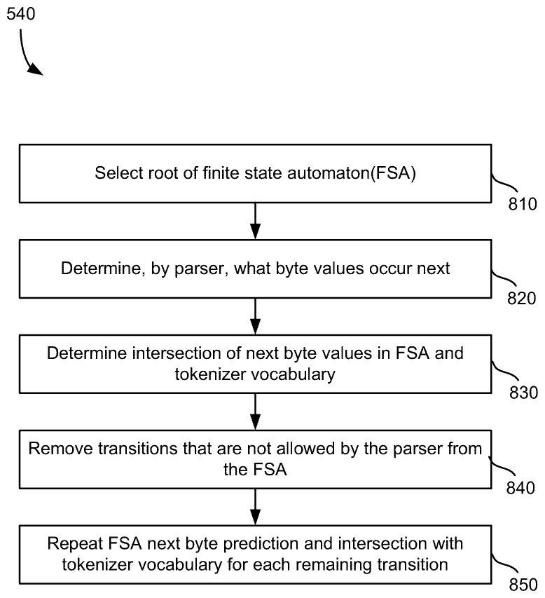

FIG. 8 is a method for performing parsing. The method of FIG. 8 provides more detail for step 540 of the method of FIG. 5. A root of a finite state automaton (FSA) is selected at step 810. A determination is then made by the parser as to what byte values occur next at step 820. Determining what byte values occur next may include preparing a prompt for consideration by a large language model. The prompt may include the root of the finite state automaton, the grammar, and the tokenizer vocabulary. The prompt may be submitted to an LLM to identify a series of tokens that may be the next token. The LLM may return a response that indicates a set of tokens that may be the next token, along with a probability of being the next token associated with each returned token in the set. The set may include the possible tokens themselves, or may identify the tokens by their assigned byte value.

The intersection of the byte values for the next possible token in the FSA and the tokenizer vocabulary are determined at step 830. Transitions that are not allowed by the parser are then removed from the FSA at step 840. The process of determining what byte values occur next, determining the intersection of the byte values in the tokenizer vocabulary, then removing transitions that are not allowed are repeated for the next byte prediction for each remaining transition in the FSA at step 850. Through this process, the FSA is reduced to make it more efficient.

To perform constrained decoding, a context free grammar is accessed and then converted to a byte-level context free grammar. A byte-level representation of a tokenizer vocabulary of the language model can be constructed, for example an FSA. A byte sequence is then parsed by a parsing mechanism to determine if the byte sequence corresponds to an allowed string prefix according to the byte-level CFG. Hence, the byte sequence parsing is constrained based on allowed string prefixes. The parsing can include parsing each incrementally generated string during left-to-right decoding of the language model. The parsing can be performed as lattice parsing on a lattice, where the lattice represents a plurality of tokens to determine a set of byte sequences that are accepted by the byte-level CFG.

The FSA, after its original formation, can be minimized. The minimized FSA can represent a set of possible byte sequences corresponding to the language model's vocabulary. The minimized FASA can also include a plurality of potential byte sequences that can be parsed simultaneously using lattice parsing.

FIG. 9 is s method for performing decoding. The method of FIG. 9 provides more detail for step 550 of the method of FIG. 5. An existing sequence of tokens is accessed at step 910. Each of the sequence of tokens may start with one token, and then have two or more tokens as the decoding process occurs. Constraints defined by a grammar are accessed at step 920. A constrained search is then performed for the next token in a sequence based on the accessed constraints at step 930. The search is constrained to continuations in the sequence that are possibly valid. The most current token is then integrated with each sequence of tokens at step 940. In some instances, integrating a token and sequence of tokens includes adding the token to each of one or more token sequences.

The probability of each token sequence is calculated at step 950. In some instances, an LLM may be used to determine the probability of a particular token from a plurality of tokens. The possible tokens, previous tokens, past conversation data, and other data may be provided to an LLM as input, along with instructions to determine the probability of each token being the next token. The LLM receives the input, processes the input, and outputs a probability for each token.

In some instances, after constraining the number of possible tokens, there may only be one possible token. In this instance, the single possible token is selected as the next token and the LLM step can be skipped. This allows for faster processing of the overall sequence.

The top scoring sequences are selected at step 960. A sequence score can be calculated as the probability of the entire sequence. The probability for a sequence of tokens can be determined by multiplying the probability of each token together. The sequences with the highest probability are selected and stored for use in determining subsequent tokens.

In some instances, a beam search can be used to determine the highest scoring sequence. For a beam search, a number of top scoring tokens, for example ten tokens, is selected. Each of the selected tokens is added to an existing sequence. For example, if there were ten top tokens and four sequences, there would be forty combinations of new tokens and sequences. The probability for each of the sequences is determined, and the top scoring sequences are selected to move forward. For example, the top four, five, ten, or some other number of sequences may be selected to move forward in the decoding process.

In some instances, for example after selecting one or more tokens having the highest probability score, a subsequent round of constrained decoding may result in no tokens being available. In this case, a system can backtrack to change one or more previous token selections to result in available tokens later in the constrained decoding process. In some instances, a grammar can be used to help determine how many iterations of decoding need to be traversed backwards. Using the grammar, the present system can traverse backwards to change a selected token that results in providing for available possible tokens in the most recent iteration.

FIGS. 10A-C illustrate models of a finite state automaton. FIG. 10A illustrates a finite state automaton having tokens of “the” and “The.”

FIG. 10B illustrates the FSA of FIG. 10 with each transition labeled with a byte value. For example, the transition between “t” and “h” is labeled with a byte value of “0”, and the transition between “T” and “h” is labeled with a byte value of “1.” The FSA of FIG. 10A uses ASCII characters to represent the byte values.

FIG. 10C illustrates the FSA of FIG. 10B but in minimized form. The FSA in FIGS. 10A and 10B had differences in only the first letter of each token—“t” and “T.” However, the paths for the tokens were completely different, despite having equivalent content of “h” and “e.” In the minimized FSA of FIG. 10C, the path difference only exists for the first part of the token, “T” and “t” respectively. The token path for the “h” and “e” for both tokens is now minimized to a single path.

FIG. 11 is a block diagram of a computing environment for implementing the present technology. System 1100 of FIG. 11 may be implemented in the contexts of the likes of machines that implement machine learning model 110, application server 110, chat application server 130, and simulation server 140. The computing system 1100 of FIG. 11 includes one or more processors 1110 and memory 1120. Main memory 1120 stores, in part, instructions and data for execution by processor 1110. Main memory 1120 can store the executable code when in operation. The system 1100 of FIG. 11 further includes a mass storage device 1130, portable storage medium drive(s) 1140, output devices 1150, user input devices 1160, a graphics display 1170, and peripheral devices 1180.

The components shown in FIG. 11 are depicted as being connected via a single bus 1195. However, the components may be connected through one or more data transport means. For example, processor unit 1110 and main memory 1120 may be connected via a local microprocessor bus, and the mass storage device 1130, peripheral device(s) 1180, portable storage device 1140, and display system 1170 may be connected via one or more input/output (I/O) buses.

Mass storage device 1130, which may be implemented with a magnetic disk drive, an optical disk drive, a flash drive, or other device, is a non-volatile storage device for storing data and instructions for use by processor unit 1110. Mass storage device 1130 can store the system software for implementing embodiments of the present invention for purposes of loading that software into main memory 1120.

Portable storage device 1140 operates in conjunction with a portable non-volatile storage medium, such as a floppy disk, compact disk or Digital video disc, USB drive, memory card or stick, or other portable or removable memory, to input and output data and code to and from the computer system 1100 of FIG. 11. The system software for implementing embodiments of the present invention may be stored on such a portable medium and input to the computer system 1100 via the portable storage device 1140.

Input devices 1160 provide a portion of a user interface. Input devices 1160 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1100 as shown in FIG. 11 includes output devices 1150. Examples of suitable output devices include speakers, printers, network interfaces, and monitors.

Display system 1170 may include a liquid crystal display (LCD) or other suitable display device. Display system 1170 receives textual and graphical information and processes the information for output to the display device. Display system 1170 may also receive input as a touch-screen.

Peripherals 1180 may include any type of computer support device to add additional functionality to the computer system. For example, peripheral device(s) 1180 may include a modem or a router, printer, and other device.

The system of 1100 may also include, in some implementations, antennas, radio transmitters and radio receivers 1190. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1100 of FIG. 11 are those typically found in computer systems that may be suitable for use with embodiments of the present invention and are intended to represent a broad category of such computer components that are well known in the art. Thus, the computer system 1100 of FIG. 11 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, iOS, ANDROID, as well as languages including Python, PHP, Java, Ruby, .NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for performing constrained decoding by a language model, comprising:
accessing a context free grammar (CFG);
converting the CFG to a byte-level CFG;
constructing a byte-level representation of a tokenizer vocabulary of the language model; and
parsing a byte sequence by a parsing mechanism to determine if the byte sequence corresponds to an allowed string prefix according to the byte-level CFG.

2. The method of claim 1, wherein parsing includes parsing each incrementally generated string during left-to-right decoding of the language model.

3. The method of claim 1, wherein parsing includes performing lattice parsing on a lattice representing a plurality of tokens to determine a set of byte sequences that are accepted by the byte-level CFG.

4. The method of claim 1, further comprising minimizing a finite state machine (FSA) that represents a set of possible byte sequences corresponding to the language model's vocabulary.

5. The method of claim 4, wherein the minimized FSA includes a plurality of potential byte sequences that can be parsed simultaneously using lattice parsing.

6. A non-transitory computer readable storage medium having embodied thereon a program, the program being executable by a processor to perform constrained decoding by a language model, the method comprising:
accessing a context free grammar (CFG);
converting the CFG to a byte-level CFG;
constructing a byte-level representation of a tokenizer vocabulary of the language model; and
parsing a byte sequence by a parsing mechanism to determine if the byte sequence corresponds to an allowed string prefix according to the byte-level CFG.

7. The non-transitory computer readable storage medium of claim 6, wherein parsing includes parsing each incrementally generated string during left-to-right decoding of the language model.

8. The non-transitory computer readable storage medium of claim 6, wherein parsing includes performing lattice parsing on a lattice representing a plurality of tokens to determine a set of byte sequences that are accepted by the byte-level CFG.

9. The non-transitory computer readable storage medium of claim 6, further comprising minimizing a finite state machine (FSA) that represents a set of possible byte sequences corresponding to the language model's vocabulary.

10. The non-transitory computer readable storage medium of claim 9, wherein the minimized FSA includes a plurality of potential byte sequences that can be parsed simultaneously using lattice parsing.

11. A system for perform constrained decoding by a language model, comprising:
one or more servers, wherein each server includes a memory and a processor; and
one or more modules stored in the memory and executed by at least one of the one or more processors to access a context free grammar (CFG), convert the CFG to a byte-level grammar, construct a byte-level representation of a tokenizer vocabulary of the language model, and parse a byte-level representation of a tokenizer vocabulary of the language model.

12. The system of claim 11, wherein parsing includes performing lattice parsing on a lattice representing a plurality of tokens to determine a set of byte sequences that are accepted by the byte-level CFG.

13. A method for decoding tokens provided by a language model, comprising:
receiving a sequence of token from a language model;
performing a constrained search for a subsequent token;
integrating the subsequent token and the sequence of tokens into two or more new sequences of tokens; and
selecting one of the two or more new sequences of tokens based on a probability score.

14. The method of claim 13, wherein a probability score is determined for each of the new sequences of tokens.

15. The method of claim 13, wherein a plurality of token sequences is received from the language model and a plurality of subsequent tokens are integrated with each of the plurality of token sequences.

16. The method of claim 15, wherein a probably score is determined for each new token sequence generated from the plurality token sequences and the plurality of tokens.

17. The method of claim 16, wherein selecting one of the plurality of new sequences includes selecting a subset of the plurality of new token sequences having the highest probability score.

18. The method of claim 11, further comprising:
determining that the constrained search results in no allowable tokens; and
changing a token selection from a previous iteration of decoding.
